(19) United States
(12) Patent Application Publication
(10) Pub. No.: US 2008/0154457 A1
(43) Pub. Date: Jun. 26, 2008

(54) Position detecting system and method of the same

(75) Inventors: Ren-Yuan Yu, Hsinchu (TW); Yung-Yu Chen, Hsinchu (TW); Shyang-Jye Chang, Hsinchu (TW); Shih-Hao Wang, Hsinchu (TW); Ming-Jye Tsai, Hsinchu (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/980,475

(22) Filed: Oct. 31, 2007

(30) Foreign Application Priority Data
Dec. 26, 2006 (TW) 095148896

(51) Int. Cl. G05D 1/00

(52) U.S. Cl. 701/26

(57) ABSTRACT

A position detecting system and a method of the same are disclosed according to the present invention as follows: an inertia sensing module and an obstacle sensing module are adapted to detect a displacement signal of a cleansing apparatus and a distance signal of a distance between the cleansing apparatus and an obstacle respectively; and then a signal processing module is adapted to convert the displacement signal and the distance signal into an actual displacement path and an obstacle distance respectively, and then compare the actual displacement path and the obstacle distance with a preset path respectively to determine if the cleansing apparatus is traveling at the same place over again, or if the cleansing apparatus is going to hit the obstacle, and then the signal processing module will adjust a traveling path based on comparison results; and a control module is adapted to control traveling of the cleansing apparatus based on the adjusted traveling path. Hence, the cleansing apparatus is capable of repeating the foregoing steps for detecting and positioning purposes at any time during a cleansing process, thereby avoiding repetitive cleaning at the same place.

### BACKGROUND OF THE INVENTION

1. Field of the Invention

This invention generally relates to position detecting systems and methods of the same, and more specifically, to a position detecting system and a method of the same, which are applicable to cleansing apparatuses.

2. Description of Related Art

At present, sensors are applied in most cleansing robots to detect signals and determine if a traveling path should be changed. Since the cleansing robots are incapable of detecting if a place has been cleaned over again, it wastes money and time unnecessarily.

To solve the aforementioned drawbacks, U.S. Pat. No. 6,732,826 discloses a cleansing robot and the cleansing robot's system and its application method, wherein a camera is used to take pictures of surroundings to determine positions; and since photo shooting and image process technologies are involved, high cost of hardware is certainly unavoidable; besides, image process consumes electricity and time.

In addition, Taiwanese Patent No. 432266 discloses a robotic floor cleansing apparatus, wherein the cleansing apparatus makes a first round of inspection by traveling around the periphery of the room to be cleansed or of an object inside the room, and during the inspection process, the cleansing apparatus is capable of dodging any obstacles on traveling path, detecting and storing data derived from sensors, when it determines that data derived from detector are same as or mostly similar to previously stored data, the cleansing apparatus travels inwards (or outwards) to complete a second round of inspection; and after each round of inspection, the cleansing apparatus continuously travels inwards (or outwards), thereby traveling approximately inwards (or outwards) in a gyrating way until floor of the room not occupied by any obstacle is all cleaned up.

The aforementioned robotic cleansing apparatus is capable of differentiating positions by making use of optical sensors or acoustic sensors to dodge any obstacles and places where have been cleansed; however, in order to make use of the robotic cleansing apparatus, for detecting purpose, a plurality of optical emitters must be installed at many different points of the room to be cleaned, thereby increasing cost.

Hence, a highly urgent issue facing the industry involves providing a technique which can effectively solve the drawbacks of conventional position detecting systems and methods for a cleansing apparatus as mentioned above.

### SUMMARY OF THE INVENTION

In view of the disadvantages of the prior art mentioned above, it is a primary objective of the present invention to provide a position detecting system and a method of the same, so as to reduce production costs.

It is another objective of the present invention to provide a position detecting system and a method of the same, so as to avoid repetitive cleansing jobs at the same place.

To achieve the aforementioned and other objectives, a position detecting system is provided according to the present invention. The position detecting system is applicable to cleansing apparatuses for detecting and positioning purposes; and the position detecting system comprises: an inertia sensing module for detecting a displacement signal of the cleansing apparatus; an obstacle sensing module for detecting a distance signal of a distance between the cleansing apparatus and an obstacle; a signal processing module for first converting the displacement signal and the distance signal into an actual displacement path and an obstacle distance respectively, and then comparing these converted data with a preset path, and then adjusting a traveling path based on the comparison results; a memory module for storing the preset path, wherein the preset path is compared with the actual displacement path and the obstacle distance, and for storing the adjusted traveling path derived from the signal processing module; and a control module for controlling traveling of the cleansing apparatus based on the preset path stored in the memory module or the adjusted traveling path derived from the signal processing module.

In addition, the position detecting system further comprises at least one contact interface module for connecting with an external device so as to input the preset path.

A position detecting method is also provided according to the present invention; the position detecting method is applicable to cleansing apparatuses for detecting and positioning purposes, and the position detecting method comprises the steps of: allowing the cleansing apparatus to travel based on a preset path; detecting a displacement signal of the cleansing apparatus; detecting a distance signal of a distance between an obstacle and the cleansing apparatus; converting the detected displacement signal and the detected distance signal into an actual displacement path and an obstacle distance respectively; comparing the actual displacement path and the obstacle distance with the preset path respectively; adjusting a traveling path based on results of comparing the actual displacement path and the obstacle distance with the preset path; and allowing the cleansing apparatus to travel based on the adjusted traveling path, and storing the adjusted traveling path.

Furthermore, the position detecting method comprises calculating an optimal traveling path from the actual displacement path, such that the optimal traveling path functions as a preset path for the next round of traveling of the cleansing apparatus.

In summary, the position detecting system and the method of the same mainly involves the steps of: when a cleansing apparatus is traveling along a preset path, allowing an inertia sensing module to detect a displacement signal of the cleansing apparatus, allowing an obstacle sensing module to detect a distance signal of a distance between the cleansing apparatus and a nearby obstacle; allowing the signal processing module to convert the displacement signal detected by the inertia sensing module and the distance signal detected by the obstacle sensing module into an actual displacement path and an obstacle distance respectively; comparing the preset path with the actual displacement path and the obstacle distance to determine if the cleansing robot is repeatedly traveling at the same area, or if the cleansing robot is going to hit the obstacle; adjusting a traveling path based on the comparison results; allowing the control module to control traveling of the cleansing apparatus based on the adjusted traveling path, thereby avoiding repetitive cleansing at the same area.

Besides, the position detecting system and the method of the same are capable of allowing users to determine and input preset path based on nearby surroundings via an external device, therefore, at each of the different places for cleansing, the cleansing apparatus is capable of calculating an optimal traveling path from the stored preset path, therefore the cleansing apparatus can complete its cleansing job in a short time.

### BRIEF DESCRIPTION OF DRAWINGS

The present invention can be more fully understood by reading the following detailed description of the preferred embodiments, with reference made to the accompanying drawings, wherein:

FIG. 1A is a schematic view of a position detecting system of the present invention;

FIG. 1B is a schematic view of a signal processing module of the present invention; and

FIG. 2 is a flow chart of a position detecting method according to the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

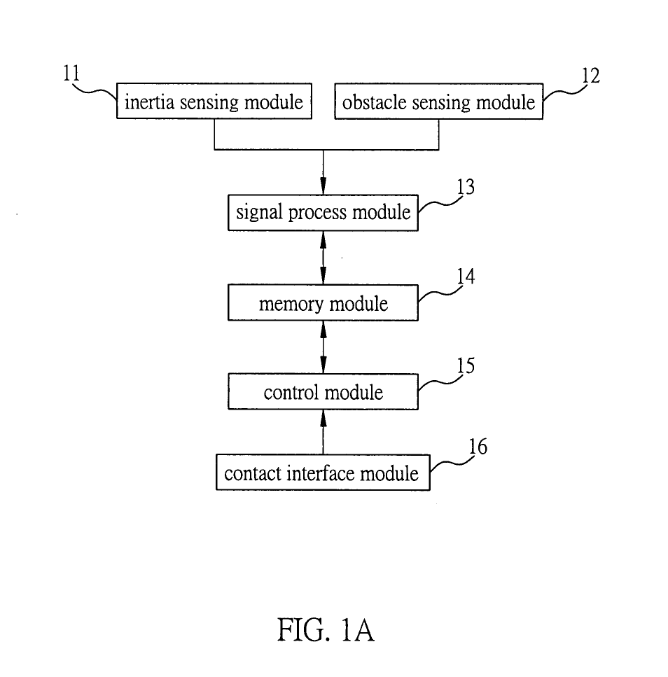

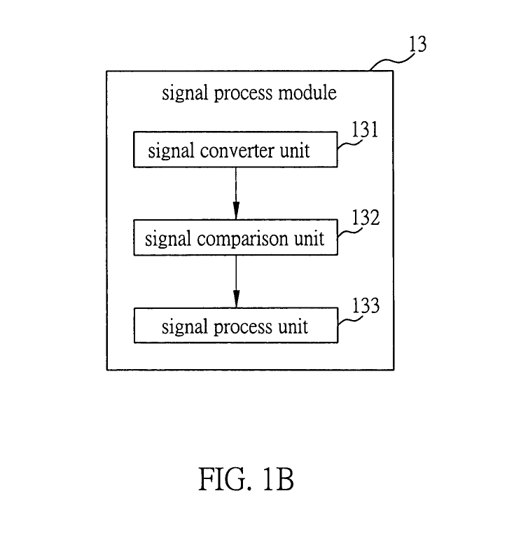

Please refer to FIG. 1A, which is a schematic view of a position detecting system according to the present invention.

As shown in the drawing, the position detecting system comprises: an inertia sensing module 11, an obstacle sensing module 12, a signal processing module 13, a memory module 14, and a control module 15; the position detecting system is applicable to a cleansing apparatus for detecting and positioning purposes, the cleansing apparatus does not repeatedly clean the same area, but performs a cleansing job quickly, wherein the cleansing apparatus is a cleansing robot.

The inertia sensing module 11 is for, when the cleansing apparatus is traveling, detecting a displacement signal of the cleansing apparatus; the inertia sensing module 11 consists of an accelerometer, e.g. MEMS accelerometer, and gyroscope, e.g. MEMS gyroscope; the accelerometer is for detecting a cross-range acceleration signal when the cleansing apparatus is traveling, namely, installing an x-y axes accelerometer on an x-y plane, and the gyroscope is for detecting an angular speed signal when the cleansing apparatus is gyrating, namely, the gyroscope is an z-axis gyroscope; and then the signal processing module 13 converts the acceleration signal and the angular speed signal into a displacement path and a gyration path respectively. The obstacle sensing module 12, which can be either an optical sensor or an acoustic sensor, detects a distance signal of a distance between the cleansing apparatus and a nearby obstacle when the cleansing apparatus is traveling.

The signal processing module 13 converts a displacement signal detected by the inertia sensing module 11 and a distance signal detected by the obstacle sensing module 12 into an actual displacement path and an obstacle distance respectively, and then compares the actual displacement path and the obstacle distance with a preset path stored in the memory module 14 to determine if the cleansing apparatus is repeatedly doing the same job at the same area, or if the cleansing apparatus is going to hit the nearby obstacle. Afterward, a traveling path is adjusted based on comparison results, wherein the signal processing module 13 is capable of calculating an optimal traveling path from the actual displacement path, and then having the optimal traveling path stored in the memory module 14 as a preset path for the next round of traveling of the cleansing apparatus.

Please further refer to FIG. 1B, the signal processing module 13 comprises: a signal converter unit 131 for converting the displacement signal and the distance signal into the actual displacement path and the obstacle distance; a signal comparison unit 132 for comparing the actual displacement path and the obstacle distance respectively with the preset path stored in the memory module to determine if the cleansing apparatus is repeatedly cleaning at the same place, or if the cleansing apparatus is going to hit the obstacle; and a signal processing unit 133 for adjusting a traveling path based on the comparison results produced by the signal comparison unit 132, wherein the signal processing unit is capable of calculating an optimal traveling path from the actual displacement path.

The memory module 14 is adapted to store the preset path, and the preset path is compared with the actual displacement path and the obstacle distance. The memory module 14 is also adapted to store the adjusted traveling path derived from the signal processing module 13.

The control module 15 is for controlling traveling of the cleansing apparatus based on the preset path stored in the memory module 14; or, when the signal processing module 13 has adjusted a traveling path based on the comparison results, in other words, when the cleansing apparatus is cleansing at the same place over again or is going to hit the obstacle, the cleansing apparatus will then travel according to the adjusted traveling path; wherein the signal processing module 13 and the control module 15 are implemented as a chip module or a single integrated module.

In addition, the position detecting system further comprises at least one contact interface module 16; the contact interface module 16 is for connecting to an external device, such as a personal digital assistant (PDA), a personal computer, and a notebook computer, therefore a user can set up a preset path based on nearby surroundings via the external device, for example, by selecting a random path as the preset path, or inputting a map of nearby surroundings, or inputting action instructions, e.g., forward five meters and turn right/left, etc.

In the present embodiment, the position detecting system of the present invention is applied in a cleansing robot (cleansing apparatus) for detecting and positioning at any time during a cleansing process; when the cleansing robot is traveling first based on a preset path stored in the memory module, the inertia sensing module detects a displacement signal of the cleansing robot, meanwhile, the obstacle sensing module detects a distance signal of a distance between the cleansing robot and a nearby obstacle; and then the signal processing module converts the displacement signal detected by the inertia sensing module and the distance signal detected by the obstacle sensing module into an actual displacement path and an obstacle distance; afterward, the preset path is compared with the actual displacement path and the obstacle distance respectively to determine if the cleansing robot is cleaning at the same place over again, or the cleansing robot is going to hit the nearby obstacle, and the comparison results serve to adjust a traveling path; and then the control module controls traveling of the cleansing robot based on the adjusted traveling path, thereby avoiding repetitive jobs at the same place and consequently saving time and money; in addition, the adjusted traveling path can be stored in the memory module and be used as a preset path for the next round of traveling of the cleansing robot, thereby achieving the goal of quick cleansing as well as enhancing cleaning efficiency.

The position detecting system can further connect with other external devices via contact interface modules, and then user can set up a preset path in advance based on nearby surroundings, for example, can input a map of nearby surroundings or directly input action instructions via electronic equipments, such as a personal digital assistant (PDA), a personal computer, and a notebook computer, and others; therefore, whenever the cleansing robot is working at different places, the signal processing module is capable of calculating an optimal traveling path based on the pre-stored preset path for the cleansing robot to complete its job in a short time.

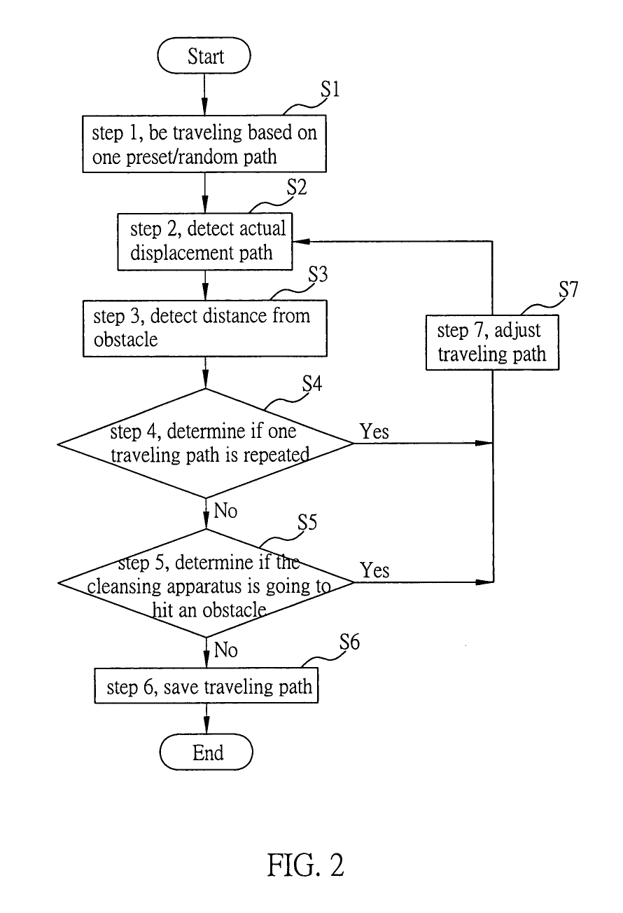

Please refer to FIG. 2, which is a flow chart of a position detecting method according to the present invention; as shown in the drawing, the position detecting method is applicable to a cleansing apparatus for detecting and positioning purposes, and the position detecting method comprises at least steps S1 through S7.

In step S1, allow the cleansing apparatus to travel based on a preset path, wherein the preset path can be a random path, a map of nearby surroundings, or action instructions inputted via an external device; proceed to step S2.

In step S2, when the cleansing apparatus is traveling, detect a displacement signal of the cleansing apparatus, and then convert the detected displacement signal into an actual displacement path; wherein the displacement signal includes a cross-range acceleration signal, which is generated when the cleansing apparatus is traveling, and an angular speed signal, which is generated when the cleansing apparatus is gyrating, in other words, convert the acceleration signal and the angular speed signal into a displacement path and a gyration path respectively; furthermore, calculate an optimal traveling path from the actual displacement path, wherein the optimal traveling path functions as the preset path for the next round of traveling of the cleansing apparatus; proceed to step S3.

In step S3, when the cleansing apparatus is traveling, detect a distance signal of a distance between the cleansing apparatus and a nearby obstacle, and then convert the distance signal into an obstacle distance; proceed to step S4.

In step S4, compare the actual displacement path with the preset path, and then determine if the cleansing apparatus is cleansing at the same area over again, if not, proceed to step S5; if yes, proceed to step S7.

In step S5, compare the obstacle distance with the preset path, and then determine if the cleansing apparatus is going to hit the nearby obstacle, if not, proceed to step S6; if yes, proceed to step S7.

In step S6, store the traveling path of the cleansing apparatus, and then the stored traveling path is to be used as the preset path for the next round of traveling of the cleansing apparatus; proceed to step S7.

Step S7 involves adjusting the traveling path based on the results of comparing the preset path with the actual displacement path and the obstacle distance, allowing the cleansing apparatus to travel based on the adjusted traveling path, and storing the adjusted traveling path. Afterward, proceed to step S2.

The position detecting system and the method of the same in accordance with the present invention are applicable to a cleansing apparatus for detecting and positioning purposes during a cleansing process, and the foregoing steps are periodically repeatable at any time; in other words, when the cleansing apparatus is traveling, it detects a displacement signal of the cleansing apparatus as well as a distance signal of a distance between the cleansing apparatus and a nearby obstacle at any time, subsequently it converts the displacement signal and the distance signal into an actual displacement path and an obstacle distance respectively, afterward, it compares the actual displacement path and the obstacle distance with the preset path, and then further determines if it is cleaning at the same place over again, or if it is going to hit the obstacle, and accordingly adjusts its traveling path anytime to avoid performing repetitive cleansing jobs at the same place; besides, the cleansing apparatus is capable of storing the adjusted traveling path as the preset path for the next round of traveling of the cleansing apparatus to enhance its cleansing efficiency.

Furthermore, the position detecting system and the method of the same of the present invention allow users to set up the preset path in advance based on nearby surroundings via an external device, and when the cleansing apparatus is working at different places, an optimal traveling path can be provided by calculating from the stored preset path, therefore, the cleansing apparatus is capable of completing job in a short time.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A position detecting system applicable to a cleansing apparatus for detecting and positioning purposes, the position detecting system comprising:
an inertia sensing module for detecting a displacement signal of the cleansing apparatus;
an obstacle sensing module for detecting a distance signal for a distance between the cleansing apparatus and an obstacle;
a signal processing module for converting the displacement signal and the distance signal into an actual displacement path and an obstacle distance respectively, comparing the actual displacement path and the obstacle distance with a preset path, and adjusting a traveling path of the cleansing apparatus based on the comparison results thus obtained;
a memory module for storing the preset path configured for comparison with the actual displacement path and the obstacle distance, and for storing the adjusted traveling path produced by the signal processing module; and
a control module for controlling traveling of the cleansing apparatus based on the preset path and the adjusted traveling path.

2. The position detecting system of claim 1, further comprising at least one contact interface module for connecting to an external device, thereby allowing users to input the preset path via the external device.

3. The position detecting system of claim 2, wherein the preset path is a random path.

4. The position detecting system of claim 2, wherein the preset path is set up by inputting action instructions based on nearby surroundings via the external device.

5. The position detecting system of claim 2, wherein the preset path is set up by inputting a map of nearby surroundings via the external device.

6. The position detecting system of claim 2, wherein the external device is one selected from the group consisting of a personal digital assistant (PDA), a personal computer, and a notebook computer.

7. The position detecting system of claim 1, wherein the signal processing module comprises:
a signal converter unit for converting the displacement signal and the distance signal into the actual displacement path and the obstacle distance;
a signal comparison unit for comparing the actual displacement path and the obstacle distance with the preset path stored in the memory module; and
a signal processing unit for adjusting the traveling path of the cleansing apparatus based on the comparison results produced by the signal comparison unit.

8. The position detecting system of claim 1, wherein the signal processing module is capable of calculating an optimal traveling path from the actual displacement path.

9. The position detecting system of claim 1, wherein the inertia sensing module consists of an accelerometer for detecting a cross-range acceleration signal when the cleansing apparatus is traveling, and a gyroscope for detecting an angular speed signal when the cleansing apparatus is gyrating.

10. The position detecting system of claim 9, wherein the acceleration signal and the angular speed signal are converted into a displacement path and a gyration path respectively by the signal processing module.

11. The position detecting system of claim 1, wherein the obstacle sensing module is one of an optical sensor and an acoustic sensor.

12. The position detecting system of claim 1, wherein the signal processing module and the control module are implemented as one of a chip module and a single integrated module.

13. A position detecting method applicable to a cleansing apparatus for detecting and positioning purposes, comprising the steps of:
allowing the cleansing apparatus to travel based on a preset path;
detecting a displacement signal of the cleansing apparatus;
detecting a distance signal of a distance between the cleansing apparatus and a nearby obstacle;
converting the displacement signal and the distance signal into an actual displacement path and an obstacle distance respectively;
comparing the actual displacement path and the obstacle distance with the preset path respectively;
adjusting a traveling path of the cleansing apparatus based on results derived from comparing the actual displacement path and the obstacle distance with the preset path; and
allowing the cleansing apparatus to travel based on the adjusted traveling path, and storing the adjusted traveling path.

14. The position detecting method of claim 13, wherein the preset path is a random path.

15. The position detecting method of claim 13, wherein the preset path is set up via an external device.

16. The position detecting method of claim 15, wherein the preset path is set up by inputting action instructions based on nearby surroundings via the external device.

17. The position detecting method of claim 15, wherein the preset path is set up by inputting a map of nearby surroundings via the external device.

18. The position detecting method of claim 15, wherein the external device is one selected from the group consisting of a personal digital assistant (PDA), a personal computer, and a notebook computer.

19. The position detecting method of claim 13, wherein the displacement signal consists of a cross-range acceleration signal generated when the cleansing apparatus is traveling, and an angular speed signal generated when the cleansing apparatus is gyrating.

20. The position detecting method of claim 19, wherein the acceleration signal and the angular speed signal are converted into a displacement path and a gyration path respectively.

21. The position detecting method of claim 13, further comprising the step of calculating an optimal traveling path from the actual displacement path, the optimal traveling path functioning as the preset path for the next round of traveling of the cleansing apparatus.
